(19) United States
(12) Patent Application Publication
(10) Pub. No.: US 2026/0179388 A1
(43) Pub. Date: Jun. 25, 2026

(54) OPTIMIZED MULTI-MODALITY PROCESSING WITH ARTIFICIAL INTELLIGENCE MODELS

(71) Applicant: NEC Laboratories America, Inc., Princeton, NJ (US)

(72) Inventors: Biplob Debnath, Princeton, NJ (US); Ravi Kailasam Rajendran, Colonia, NJ (US); Murugan Sankaradas, Dayton, NJ (US); Srimat Chakradhar, Manalapan, NJ (US)

(21) Appl. No.: 19/414,673

(22) Filed: Dec. 10, 2025

Related U.S. Application Data
(60) Provisional application No. 63/736,125, filed on Dec. 19, 2024.
(60) Provisional application No. 63/775,528, filed on Mar. 21, 2025.
(60) Provisional application No. 63/811,044, filed on May 23, 2025.

(51) Int. Cl. G06V 20/56; G06F 18/23; G06F 40/30; G06N 3/092

(52) U.S. Cl. CPC G06V 20/56; G06F 18/23; G06F 40/30; G06N 3/092

(57) ABSTRACT

Systems and methods for optimized multi-modality processing with artificial intelligence models. Relevant page images can be extracted from a multi-modality index with a dynamic multi-modality processing (DMMP) system. Semantic and contextual relationship can be captured between a user query and multi-modality content of the relevant page images. The multi-modality content of the relevant page images can be converted to an instruction code based on the semantic and contextual relationship captured with a context learning module of the DMMP system. An issue identified by the DMMP system based on the instruction code that includes the user query can be corrected by generating a corrective action with the DMMP system by utilizing the instruction code.

### RELATED APPLICATION INFORMATION

This application claims priority to U.S. Provisional App. No. 63/736,125, filed on Dec. 19, 2024, to U.S. Provisional App. No. 63/775,528, filed on Mar. 21, 2025, and to U.S. Provisional App. No. 63/811,044, filed on May 23, 2025, incorporated herein by reference in their entirety.

### BACKGROUND

### Technical Field

The present invention relates to multi-modality processing with artificial intelligence (AI), and more particularly to optimized multi-modality processing with artificial intelligence models.

### Description of the Related Art

AI models have been progressing in a rapid state due to their popularity. AI models have been used for image processing and video processing. However, AI models can be specialized for the modality that is trained on which can result in inaccurate predictions for other modalities.

### SUMMARY

According to an aspect of the present invention, a method is provided including extracting relevant page images from a multi-modality index with a dynamic multi-modality processing (DMMP) system, capturing semantic and contextual relationship between a user query and multi-modality content of the relevant page images, converting the multi-modality content of the relevant page images to an instruction code based on the semantic and contextual relationship captured with a context learning module of the DMMP system, and correcting an issue identified by the DMMP system based on the instruction code that includes the user query by generating a corrective action with a large language model that utilizes the instruction code.

According to another aspect of the present invention, a system is provided including a memory device, one or more processor devices operatively coupled with the memory device to perform operations including, extracting relevant page images from a multi-modality index with a dynamic multi-modality processing (DMMP) system, capturing semantic and contextual relationship between a user query and multi-modality content of the relevant page images, converting the multi-modality content of the relevant page images to an instruction code based on the semantic and contextual relationship captured with a context learning module of the DMMP system, and correcting an issue identified by the DMMP system based on the instruction code that includes the user query by generating a corrective action with a large language model that utilizes the instruction code.

According to yet another aspect of the present invention, a non-transitory computer program product is provided including a computer-readable storage medium including a program code, wherein the program code when executed on a computer causes the computer to perform operations including, extracting relevant page images from a multi-modality index with a dynamic multi-modality processing (DMMP) system, capturing semantic and contextual relationship between a user query and multi-modality content of the relevant page images, converting the multi-modality content of the relevant page images to an instruction code based on the semantic and contextual relationship captured with a context learning module of the DMMP system, and correcting an issue identified by the DMMP system based on the instruction code that includes the user query by generating a corrective action with a large language model that utilizes the instruction code.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for optimized multi-modality processing with artificial intelligence models, in accordance with an embodiment of the present invention;

FIG. 2 is a block diagram that shows a computer system for optimized multi-modality processing with artificial intelligence models, in accordance with an embodiment of the present invention;

FIG. 3 is a block diagram that shows software and hardware components of a computer device for optimized multi-modality processing with artificial intelligence models, in accordance with an embodiment of the present invention;

FIG. 4 is a block diagram that shows a neural network for optimized multi-modality processing with artificial intelligence models, in accordance with an embodiment of the present invention;

FIG. 5 is a flow diagram that shows a high-level overview of a method for optimized multi-modality processing with artificial intelligence models, in accordance with an embodiment of the present invention;

FIG. 6 is a block diagram that shows a practical application in a traffic scene for optimized multi-modality processing with artificial intelligence models, in accordance with an embodiment of the present invention; and

FIG. 7 is a block diagram that shows a practical application in a traffic scene for optimized multi-modality processing with artificial intelligence models, in accordance with an embodiment of the present invention.

### DETAILED DESCRIPTION OF PREFERRED EMBODIMENTS

In accordance with embodiments of the present invention, systems and methods are provided for optimized multi-modality processing with artificial intelligence models.

In the present embodiments, relevant page images can be extracted from a multi-modality index with a dynamic multi-modality processing (DMMP) system. Semantic and contextual relationship can be captured between a user query and multi-modality content of the relevant page images. The multi-modality content of the relevant page images can be converted to an instruction code based on the semantic and contextual relationship captured with a context learning module of the DMMP system. An issue identified by the DMMP system based on the instruction code that includes the user query can be corrected by generating a corrective action with the DMMP system by utilizing the instruction code.

Large language models (LLMs) are advanced AI models trained on extensive textual datasets to generate human-like language, driving significant advancements in natural language processing (NLP). LLMs offer user-friendly application programming interfaces (APIs), making them widely adopted for applications like context-aware chatbots, real-time language translation, and text summarization. These capabilities have transformed user experiences across industries by enabling more efficient and intelligent interactions.

Despite their versatility, LLMs have a notable limitation: they cannot process proprietary enterprise data, as such information lies outside their training corpus. To address this, enterprise-specific data can be integrated with LLMs to enable responses tailored to industry-specific terminology, workflows, and context, resulting in more accurate and relevant outputs for business applications.

One popular approach to enable LLMs to handle enterprise-specific data is Retrieval-Augmented Generation (RAG). RAG combines LLMs with retrieval mechanisms that access relevant information from enterprise knowledge bases. When a query is posed, the system retrieves relevant text chunks from the knowledge base and provides them as context to the LLM, allowing it to generate informed responses.

However, conventional RAG systems are predominantly text-focused, relying on chunked text as the primary retrieval unit. Enterprise documents are processed as plain text, divided into smaller chunks, and retrieved based on their relevance to the query. While this approach works for text-heavy content, it fails to account the multi-modality nature of many enterprise documents.

Enterprise information often exists in multi-modality formats, such as white papers, technical manuals, or reports, which combine text with non-textual elements like figures, charts, tables, images, and flowcharts. These multi-modality components convey meaning, structure, and context-particularly in domains like finance, healthcare, engineering, manufacturing, and legal services. Ignoring such visual and structural elements in text-based RAG systems can result in significant information loss, limiting their ability to provide comprehensive and accurate responses.

With recent advancements in multi-modality language models which can process both text and images as context, specialized vision-language models (VLMs) have been developed. These models are designed to process enterprise documents as images, leveraging the intuition that humans perceive information holistically, without explicitly distinguishing between text and images.

When using these VLMs, PDF documents are divided into individual page images. Each page is embedded using the VLMs and stored in the knowledge base of retrieval-augmented generation (RAG) systems. Upon receiving a query, the system retrieves the relevant page images from the knowledge base and feeds them into a multimodal large language model. This enables the generation of responses to queries involving enterprise multimodal documents, seamlessly incorporating both textual and visual elements.

Processing multimodal enterprise documents either solely as text or exclusively as images carries an inherent risk of information loss, as these methods may fail to fully capture the nuances and interplay between textual and visual elements present in the original document. For instance, tables, charts, or diagrams might lose contextual meaning when processed as text, while subtle textual details such as font emphasis, annotations, or layout positioning could be overlooked when processing only images. Such information loss can lead to incomplete or incorrect responses, particularly in use cases requiring a deep understanding of the document's structure and content.

To address this limitation, some systems can employ a more robust approach by analyzing documents as a combination of both text and images. In these systems, each page of the document is first converted into an image, and the text content is extracted from the image through OCR or similar techniques. Both the text and the image representation of each page are then provided for analysis, enabling the system to consider textual data alongside its visual context.

This dual-representation approach significantly enhances the accuracy of the system, as it ensures that no critical visual or textual detail is ignored. By preserving the relationships between text and visuals, such systems can better interpret charts, diagrams, and complex layouts, resulting in more accurate and reliable responses. However, this approach comes with tradeoffs: it increases the processing time required to analyze each document, as both text extraction and image processing must occur for every page. Additionally, it incurs higher computational costs, as analyzing both modalities simultaneously demands more resources.

To resolve these challenges, the present embodiments can dynamically process multi-modality input data by optimizing the representation of the multi-modality input data by utilizing reinforcement learning. By doing so, the present embodiments can retain the accuracy of multi-modality representation while optimizing processing efficiency and reducing computational resource costs.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

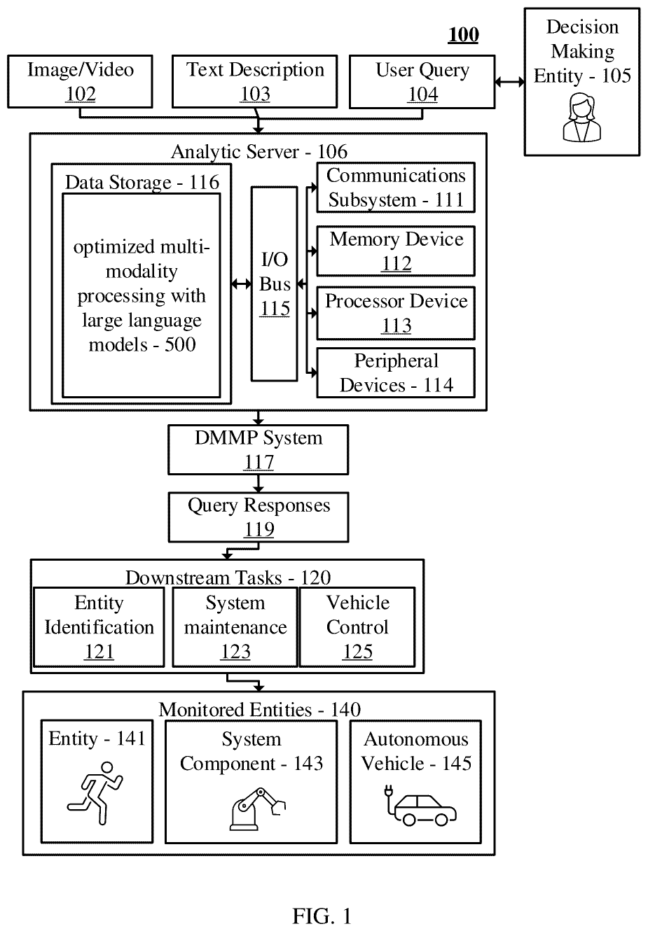

Referring now in detail to the figures in which like numerals represent the same or similar elements and initially to FIG. 1, a block diagram shows a system for optimized multi-modality processing with artificial intelligence models, in accordance with an embodiment of the present invention.

In an embodiment using a system 100, monitored entities 140 can include entity 141, system component 143, and autonomous vehicle 145. The monitored entities 140 can generate an image/video 102. The image/video 102, text descriptions 103 and user queries 104 obtained from decision making entity 105 can be transmitted to an analytic server 106 that can implement optimized multi-modality processing with artificial intelligence models 500. The analytic server 106 can obtain a dynamic multi-modality processing (DMMP) system 117 that can generate query responses 119 which can be utilized to perform downstream tasks 120.

System 100 can be utilized to perform downstream tasks 120 based on the image/video 102 and user query 104 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the image/video 102 or text description 103 (e.g., location images, scene images, entity images such as parts of the entity, etc.) related to the entity 141 can be processed by the analysis server 106 to answer user query 104 based on the query responses 119 by the analysis server 106. The user query 104 can be relevant to the entity 141 such as their attributes (e.g., position, direction of movement, color of clothing, etc.), relationship with other entities within a scene (e.g., proximity, behavior, etc.), relationship with the environment, etc. The DMMP system 117 can predict future attributes, and relationships of the entity 141.

Based on the predictions of the DMMP system 117, a corrective action can be generated by the DMMP system 117. The corrective action can include notifying the decision making entity 105 of the predictions about the entity 141 based on their image/video 102, generating solutions to an issue caused by the entity (e.g., the entity 141 as a disabled vehicle in a traffic scene and the solution is the deployment of a repair technician, etc.) of the image/video 102 to help with the decision making process of the decision making entity 105, etc.

In system maintenance 123, image/video 102 or text description 103 (e.g., system logs, test cases, hardware status images, etc.) related to the system component 143 can be processed to answer user query 104 based on based on the query responses 119 for the system component 143 generated by the analysis server 106. The user query 104 can be relevant on how to properly maintain the system component 143, or whether the system component is properly functioning based on the input image/video 102. A corrective action can be generated by the analytic server 106 which can include the answer to the user query 104 (e.g., determined causes to bandwidth issues, etc.) to maintain the system component 143. Based on the corrective action (e.g., adding bandwidth, blocking packets from an identified internet protocol (IP) address to resolve malicious attacks, restarting hardware, redirecting processing of component, etc.) the network system can be autonomously maintained.

In vehicle control 125, image/video 102 (e.g., vehicle part status, traffic scene image/video, etc.) related to the autonomous vehicle 145 can be processed to answer user query 104. The user query 104 can be relevant to how to control the autonomous vehicle 145 given its environment based on the image/video 102 or text description 103. A corrective action can be generated by the analytic server 106 which can include the answer to the user query 104 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory based on the query responses 119 generated by the analysis server 106 such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune/train the DMMP system 117.

Other downstream tasks and practical applications are contemplated.

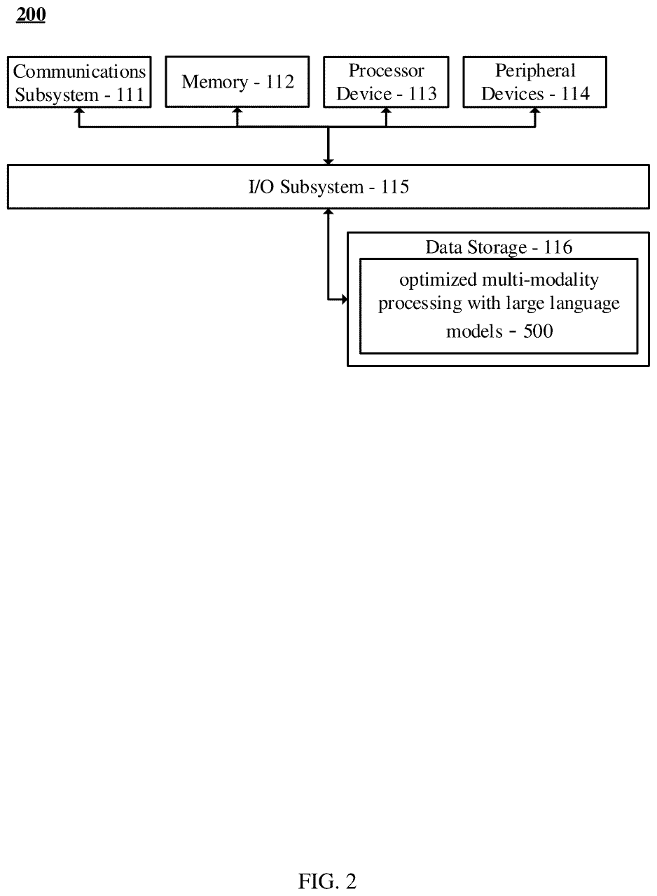

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for optimized multi-modality processing with artificial intelligence models, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for optimized multi-modality processing with artificial intelligence models 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

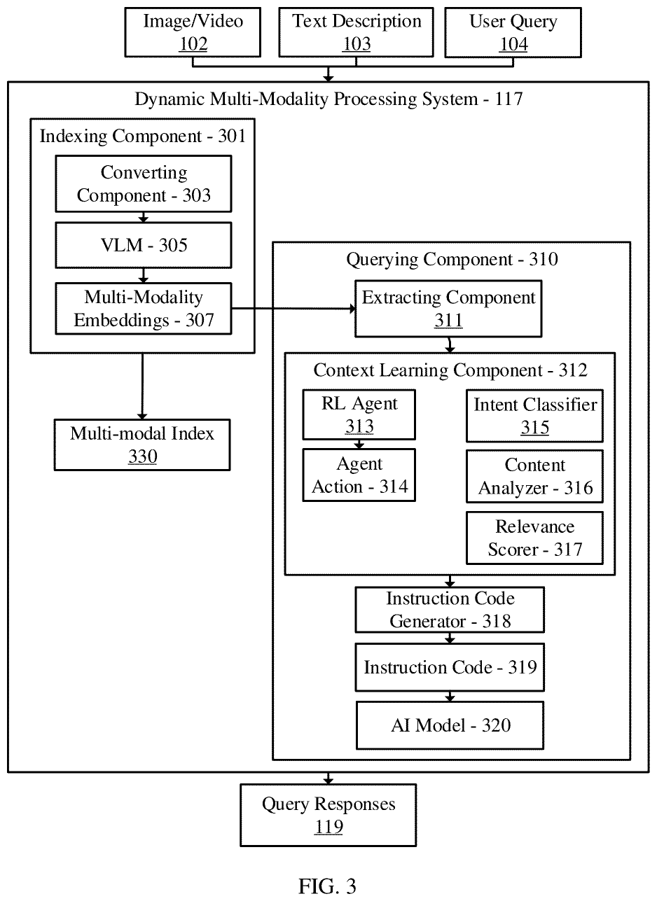

Referring now to FIG. 3, a block diagram shows software and hardware components of a computer device for optimized multi-modality processing with artificial intelligence models, in accordance with an embodiment of the present invention.

In an embodiment, dynamic multi-modality processing (DMMP) system 117 can process multiple modalities including image/video 102, text description 103 and user query 104 to generate query responses 119.

The DMMP system 117 can include an indexing component 301 and a querying component 310. The indexing component 301 can include a converting component 303 that converts input data (e.g., image/video 102, text description 103) into a processing code for visual language model (VLM) 305 to generate multi-modality embeddings 307. In an embodiment, input video can be processed by the DMMP system 117 into image frames.

The multi-modality embeddings 307 can be processed by the querying component 310. The querying component 310 can include an extracting component 311 that can extract semantic and contextual information from the multi-modality embeddings 307 based on relevance to the user query 104 by utilizing a context learning component 312. The context learning component 312 can include a reinforcement learning (RL) agent 313 to generate an agent action 314 based on a state representation generated from the semantic and contextual information determined by the RL agent 313. The agent action 314 can be processed by the instruction code generator 318 to generate an instruction code 319 for AI model 320 to generate the query response 119. In an embodiment, the AI model 320 can utilize a large language model.

In another embodiment, the context learning component 312 can include an intent classifier 315, a content analyzer 316, and a relevance scorer 317. The intent classifier 315 can classify the input data based on the multi-modality embeddings 307. The content analyzer 316 can analyze and extract the data from the input data based on the modality of the input data. The relevance score 317 can ensure that the data from the input data is relevant to the user query 104.

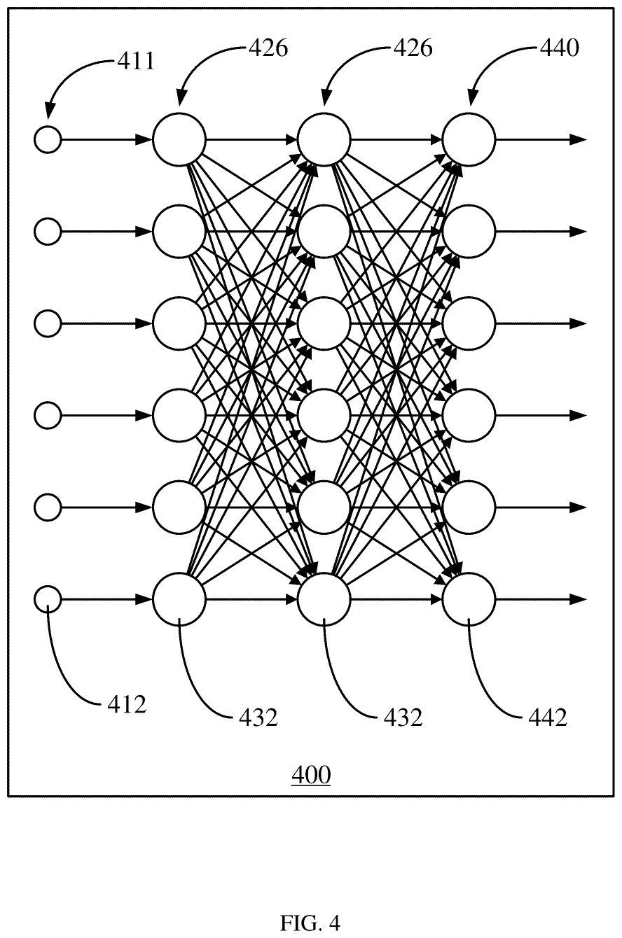

Referring now to FIG. 4, a block diagram shows a neural network for optimized multi-modality processing with artificial intelligence models, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 400, such as a multilayer perceptron, can have an input layer 411 of source neurons 412, one or more computation layer(s) 426 having one or more computation neurons 432, and an output layer 440, where there is a single output neuron 442 for each possible category into which the input example could be classified. An input layer 411 can have a number of source neurons 412 equal to the number of data values 412 in the input data 411. The computation neurons 432 in the computation layer(s) 426 can also be referred to as hidden layers, because they are between the source neurons 412 and output neuron(s) 442 and are not directly observed. Each neuron 432, 442 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 432 in the one or more computation (hidden) layer(s) 426 perform a nonlinear transformation on the input data 412 that generates a feature space. The classes or categories may be more easily separated in the feature space than in the original data space.

In an embodiment, the neural network 400 can be utilized by the RL agent 313 to update its hidden layers to learn the state representation based on the semantic and contextual information from the multi-modality embeddings 307. The RL agent 313 can generate an agent action 314 based on corresponding rewards for potential actions based on the state representation and the context of the environment.

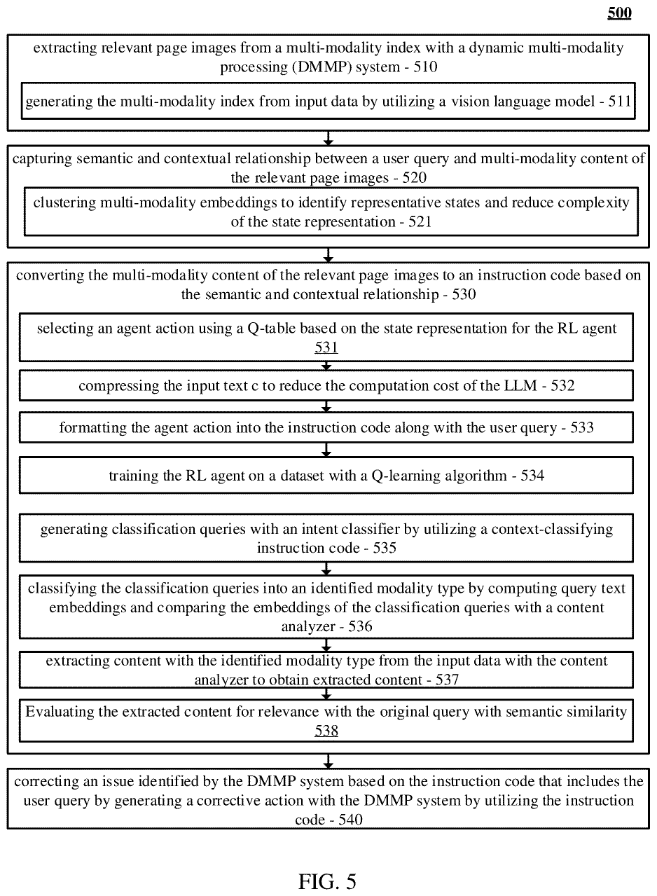

Referring now to FIG. 5, a flow diagram shows a high-level overview of a method for optimized multi-modality processing with artificial intelligence models, in accordance with an embodiment of the present invention.

In an embodiment, relevant page images can be extracted from a multi-modality index with a dynamic multi-modality processing (DMMP) system. Semantic and contextual relationship can be captured between a user query and multi-modality content of the relevant page images. The multi-modality content of the relevant page images can be converted to an instruction code based on the semantic and contextual relationship captured with a context learning module of the DMMP system. An issue identified by the DMMP system based on the instruction code that includes the user query can be corrected by generating a corrective action with the DMMP system by utilizing the instruction code.

In block 510, relevant page images can be extracted from a multi-modality index with a dynamic multi-modality processing (DMMP) system.

In an embodiment, relevant page images can be extracted from the multi-modality index 330. The multi-modality index 330 can be generated from the input data (e.g., image/video 102, text description 103).

In block 511, the multi-modality index can be generated from input data by utilizing a vision language model.

The indexing component 301 can construct an efficient and comprehensive index of document page images using vision-language model 305. These state-of-the-art models can process and understand both visual and textual content within a single framework. Each document page can be represented as an image through the converting component 303. The relevant page images can be passed through these VLM 305, which can generate rich embeddings having a unified representation that capture both the visual elements (e.g., charts, tables, images, and layout) and the textual content (e.g., paragraphs, headings, and annotations).

When a user query 104 is received, the DMMP system 117 can identify and extract the most relevant page images from the multi-modality index 330. To extract the relevant page images, efficient search algorithms that match the query against the structured embeddings of document pages can be utilized, ensuring that the system can quickly locate pages with the highest semantic and contextual relevance.

By unifying visual and textual data into a single representation, this approach allows the DMMP system 117 to effectively capture relationships between elements within the document (e.g., spatial positioning of text, alignment of tables, or associations between images and captions). This indexing process ensures that the DMMP system 117 is equipped to handle complex queries that require a nuanced understanding of both modalities, providing a robust and scalable solution for multimodal document retrieval and analysis.

In block 520, semantic and contextual relationship can be captured between a user query and multi-modality content of the relevant page images. In an embodiment, the state representation can be formed to capture semantic and contextual relationship between a user query 104 and the multi-modality content of the relevant page images.

The state representation can be characterized by embeddings that capture the semantic and visual features of the user query 104, along with the corresponding document's image and/or text content. The state representation can be represented as s=[q, v_{img}, vₜₑₓₜ>|q−v_{img}|, |q−vₜₑₓₜ|], where q is the user query embedding, v_{img} is the image embedding, and vₜₑₓₜ is the text embedding.

In block 521, multi-modality embeddings can be clustered to identify representative states and reduce complexity of the state representation.

The multi-modality embeddings 307 can be processed and clustered using K-means to identify representative states. This clustering helps reduce the complexity of the state representation while retaining meaningful distinctions between different types of queries and documents.

The state representation can be generated by the RL agent 313. The RL agent 313 can be trained to evaluate the multi-modality content of the pages in the context of the user query 104 and decide the most efficient input modality for the AI model 320. The agent action 314 can include providing a single modality or providing a mixed modality with the user query 104.

In block 530, the multi-modality content of the relevant page images can be converted to an instruction code based on the semantic and contextual relationship captured with a context learning module of the DMMP system. In an embodiment, the multi-modality content of the relevant page images can be converted to an instruction code 319 based on the action selected by the RL agent 313. The action selected by the RL agent 313 is based on the state representation and corresponding rewards.

In block 531, the RL agent 313 can select an action using a Q-table based on the state representation.

In an embodiment, the Q-table can include action and corresponding rewards based on the current context of the environment of the RL agent 313. For example, the context of the environment of the RL agent 313 can include image-only input, text-only input and combined input. In a case with image-only input: if the page contains primarily visual elements (e.g., diagrams, charts, or spatially dependent layouts), the RL agent 313 chooses to use the image representation as the input. In a case with text-only input: if the page is dominated by textual data or the visual elements are not critical for answering the query, the RL agent 313 opts to extract and input text alone. In a case with combined input: for pages where both visual and textual elements are essential to accurately answer the query, the RL agent 313 selects both modalities as inputs. If the action of the RL agent 313 involves text input (either text-only or combined input), the system extracts the textual content from the selected page images using Optical Character Recognition (OCR) or similar methods.

The reward function is designed to balance two key objectives: accuracy and cost efficiency. Accuracy ensures that the query is answered correctly, retaining all necessary information. Cost Efficiency minimizes application programming interface (API) usage and query processing time. For example, the reward function can be represented as

$$R = α \cdot \frac{A}{{A}_{ref}} - β \cdot C - γ \cdot L ,$$

where α. encourages accuracy retention, β penalizes cost, γ penalizes latency, A_{ref}: accuracy using image-only (baseline), A: accuracy under the selected action, C: cost (token count or API cost) and L: latency (in seconds).

The reward is higher when the chosen action leads to accurate responses with reduced resource utilization. For example, successfully answering a query with a text-only input (when visual data isn't required) yields a higher reward than using combined input unnecessarily. If an image is necessary for accuracy, the accuracy term can outweigh the cost. If both modalities are necessary, the combined action for both modalities can be utilized. If both modalities are unnecessary, a text-only modality can generate a high reward.

At runtime, the trained RL agent 313 leverages the Q-table to select the most efficient action for a given query-state pair. For each incoming query, the RL agent 313 identifies its corresponding state based on the embeddings of the query and associated document (image and/or text).

Using the Q-table, the RL agent 313 retrieves the action with the highest Q-value for the given state. This ensures the optimal balance between accuracy and cost efficiency.

In block 532, input text can be compressed to reduce the computation cost of the LLM. The input text can be compressed by summarizing or extracting query-relevant portions, reducing the token count and, consequently, the computational cost of the LLM.

In block 533, the agent action can be formatted into an instruction code with the user query to generate a comprehensive and accurate response from the LLM.

The agent action 314 can be formatted into an instruction code 319 along with the user query. This multimodal instruction code 319 serves as the input to the AI model 320, enabling it to generate a comprehensive and accurate response.

In block 534, the RL agent can be trained on a dataset with a Q-learning algorithm. In an embodiment, a Q-learning algorithm can be employed to train the RL agent 313 on a dataset comprising diverse queries, documents, and corresponding predefined actions.

The Q-table, which serves as the core of the algorithm, maps each state (representing the query and document context) to the expected rewards of all possible actions. During training, the Q-learning algorithm updates the Q-values iteratively using the Bellman equation:

$$Q ( s , a ) ← Q ( s , a ) + α ( r + γ {max}_{a ′} Q ( {s}^{′} , {a}^{′} ) - Q ( s , a ) ) ,$$

where s is the current state, a is the chosen action, r is the reward received, s′ is the next state, a′ is the next chosen action, and a and y are the learning rate and discount factor, respectively. The RL agent 313 can learn an optimal policy by exploring different actions and maximizing the cumulative reward.

In another embodiment, the multi-modality content of the relevant page images can be converted to an instruction code 319 by utilizing a context learning component 312 that includes an intent classifier 315, content analyzer 316 and a relevance scorer 317.

In block 535, classification queries can be generated with an intent classifier by utilizing a context-classifying instruction code. In an embodiment, the intent classifier 315 can leverage a context-classifying instruction code to generate a set of classification queries using AI model 320. The context-classifying instruction code can include the following format: “<domain instruction><task instructions><task goals><expected output>”. For example, the context-classifying instruction code can include, “You are an expert in document understanding. Your task is to generate representative user queries that would be issued to a document question-answering system. For each query, classify the preferred modality required to answer it accurately: ‘text’: The query can be answered reliably using only OCR-extracted plain text from the document. ‘pageimage’: The query requires visual cues such as layout, spatial relationships, formatting, tables, handwritten elements, or other non-textual features. Generate a list of 10 diverse queries for each modality. For each query, provide a short explanation of why the specified modality is required. Expected JSON Output Format: {‘text_samples’: [{‘query’: ‘ . . . ’, ‘reason’: . . . ‘}, . . . ], ‘pageimage_samples’: [{‘query’: ‘ . . . ’, ‘reason’: ‘.’}, . . . }.”

The classification queries generated by the LLM can involve understanding the visual layout, spatial relationships, or visual characteristics of the page often require processing the image representation. In contrast, classification queries that focus on retrieving specific facts or textual information can typically be answered more efficiently using the text version. For example, questions like “Is there a signature at the bottom?” or “What color is the chart?” rely on visual cues from the image, whereas queries such as “List all items in the table” or “What is the invoice number?” can be addressed directly from the text data.

In block 536, the classification queries can be classified into an identified modality type by computing query text embeddings and comparing the embeddings of the classification queries with a content analyzer. In an embodiment, to classify the queries based on the classification queries generated by the AI model 320, the context learning component 312 can compute query text embedding sand compares it against the embeddings of the pre-generated questions in both lists. The similarity between the query embedding and each question embedding is computed. For each modality, the similarity scores across all associated questions are averaged. The corresponding modality-image or text, with the highest averaged similarity is then assigned to the query, guiding the decision on whether to process the each of the retrieved pages as an image or text.

In block 537, content with the identified modality type can be extracted from the input data with the content analyzer to obtain extracted content. In an embodiment, the context learning component 312 can utilize a content analyzer 316 that utilizes a layout detector to determine the presence of textual content on the page. If text is detected, the page is processed using an optical character recognition (OCR) engine to extract the text. If the decision is to use the image representation, the page is directly fed as an image to the AI model 320 to generate an answer. On the other hand, if text-based processing is identified, additional steps are taken to ensure that the extracted text is relevant to the query.

In block 538, the extracted content can be evaluated for relevance with the original query with semantic similarity. In an embodiment, the extracted content can be evaluated for relevance to the original query with semantic similarity computed by the relevance scorer 317. If the similarity score exceeds a predefined threshold (e.g., can be set to 0.45), the OCR-extracted text is used to generate the answer. Otherwise, the page is processed as an image to ensure that any important visual context is not overlooked. The extracted content evaluated for relevance can be utilized in the instruction code 319 that is generated by the instruction code generator 318.

The present embodiments can balance computational efficiency, cost, and answer accuracy. Visually rich or non-textual pages are processed as images to retain critical context, while pages with relevant, structured text are handled via faster, more cost-effective text-based inference. This adaptive strategy reduces the reliance on expensive image processing while improving the relevance and quality of the answers generated.

In block 540, an issue identified by the DMMP system based on the instruction code that includes the user query can be corrected by generating a corrective action with a DMMP system that utilizes the instruction code.

In an embodiment, an issue identified by the dynamic multi-modality processing system 117 based on the instruction code 319 that includes the user query 104 can be corrected by generating a corrective action with the DMMP system 117 including a large language model.

The user queries 104 can focus on retrieving specific facts or textual information can typically be answered more efficiently using the text version. For example, questions like “is there a signature at the bottom?” or “what color is the chart?” rely on visual cues from the image whereas queries such as “list all items in the table” or what is the invoice number?” can be addressed directly through the text.

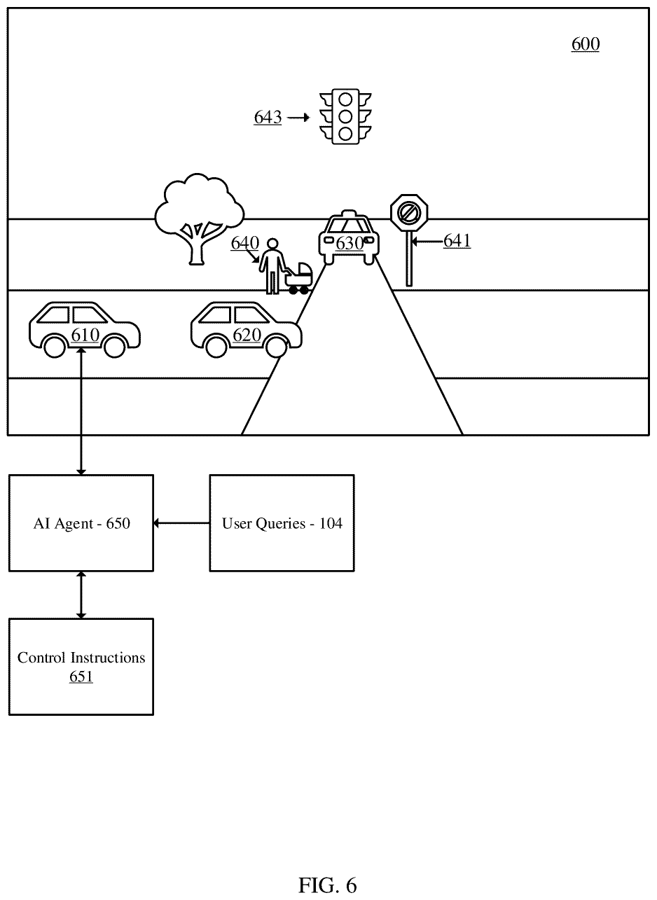

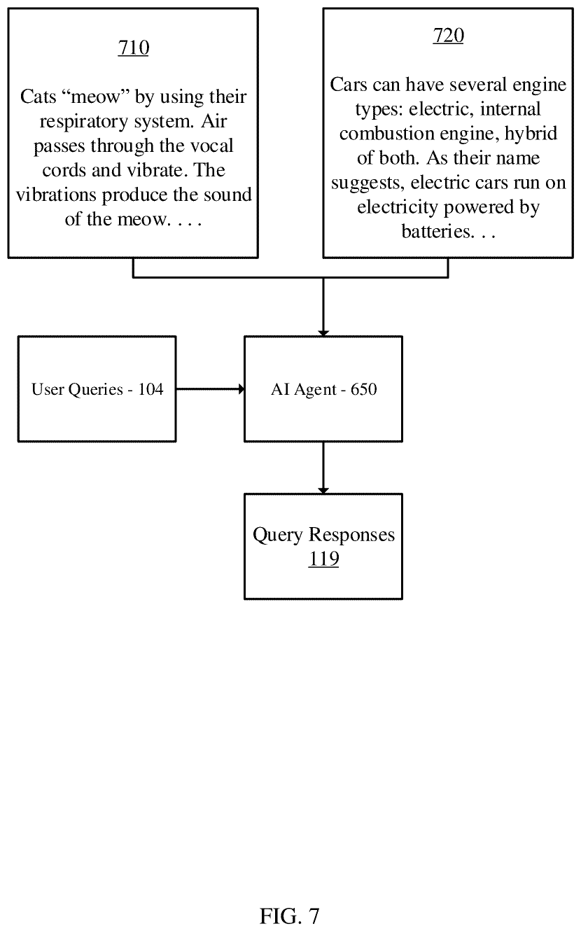

The corrective actions can be described in more detail in FIG. 6 and FIG. 7.

Referring now to FIG. 6, a block diagram shows a practical application in a traffic scene for optimized multi-modality processing with artificial intelligence models, in accordance with an embodiment of the present invention.

In an embodiment, in traffic scene 600, vehicle 610 can communicate with an AI agent 650 that can utilize analytic server 106 through a network. Input videos 102 can be processed by vehicle 610 through the analytic server 106 through the network. The AI agent 650 can process the input videos 102 and generate control instructions 651 and control the vehicle 610 based on the query responses 119 (e.g., speeding up, braking, change direction, etc.).

Vehicle 610 can autonomously understand the traffic scene 600 and generate trajectories based on the traffic scene. The trajectories can include predictions of trajectories of the entities in the traffic scene 600 based on user queries 104. For example, the user queries 104 can include “is there a vehicle in front of us which can potentially collide with another vehicle?”. AI agent 650 can generate a response which can include “No, vehicle (620) is in the intersection where pedestrian (640) is also crossing the intersection. Taxi (630) is stopped behind one-way sign (641) as the light on (643) is red for taxi (630) and green for vehicle (620).”

In another embodiment, in traffic scene 600, vehicle 610 can simulate trajectories for the identified entities. In another embodiment, in traffic scene 600, based on the simulated trajectories of the identified entities, vehicle 610 can generate a trajectory to avoid the simulated trajectories of the identified entities and avoid collisions. In another embodiment, the vehicle 610 can be autonomously controlled based on the generated trajectory to avoid collisions.

Referring now to FIG. 7, a block diagram shows a practical application in a traffic scene for optimized multi-modality processing with artificial intelligence models, in accordance with an embodiment of the present invention.

In an embodiment, input text descriptions 103, including text descriptions 710 and 720, can be processed by the AI agent 650 to answer user queries 104 and generate query responses 119. The text descriptions 103 can include sensor/status readings for a monitored entity 140. For example, user queries 104 can include “Is there something wrong with my car, here is a picture of my car with the hood open.” The AI agent 650 can disregard the text description 710 as it is irrelevant to the user query 104. The query response 119 based on the example can include “Yes, your engine is overheating based on the smoke coming out from the engine bay. I called the towing service to help you move your car as it is not recommended to drive with an overheating engine.”

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of′, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
extracting relevant page images from a multi-modality index with a dynamic multi-modality processing (DMMP) system;
capturing semantic and contextual relationship between a user query and multi-modality content of the relevant page images;
converting the multi-modality content of the relevant page images to an instruction code based on the semantic and contextual relationship captured with a context learning module of the DMMP system; and
correcting an issue identified by the DMMP system based on the instruction code that includes the user query by generating a corrective action with the DMMP system by utilizing the instruction code.

2. The method of claim 1, wherein extracting the relevant page images further comprises generating the multi-modality index from input data by utilizing a vision language model.

3. The method of claim 1, wherein capturing the semantic and contextual relationship further comprises clustering multi-modality embeddings to identify representative states and reduce complexity of a state representation.

4. The method of claim 3, wherein converting the multi-modality content further comprises selecting an agent action using a Q-table based on the state representation for a reinforcement learning agent.

5. The method of claim 4, wherein converting the multi-modality content further comprises formatting the agent action into the instruction code along with the user query.

6. The method of claim 1, wherein converting the multi-modality content further comprises generating classification queries with an intent classifier by utilizing a context-classifying instruction code.

7. The method of claim 6, wherein converting the multi-modality content further comprises classifying the classification queries into an identified modality type by computing query text embeddings and comparing the embeddings of the classification queries with a content analyzer.

8. The method of claim 7, wherein converting the multi-modality content further comprises extracting content with the identified modality type from input data with the content analyzer to obtain extracted content.

9. The method of claim 1, wherein the corrective action further comprises controlling an autonomous vehicle with trajectories generated based on input videos processed by the DMMP system to avoid potential collisions.

10. A system, comprising:
a memory device;
one or more processor devices operatively coupled with the memory device to perform operations including:
extracting relevant page images from a multi-modality index with a dynamic multi-modality processing (DMMP) system;
capturing semantic and contextual relationship between a user query and multi-modality content of the relevant page images;
converting the multi-modality content of the relevant page images to an instruction code based on the semantic and contextual relationship captured with a context learning module of the DMMP system; and
correcting an issue identified by the DMMP system based on the instruction code that includes the user query by generating a corrective action with the DMMP system by utilizing the instruction code.

11. The system of claim 10, wherein extracting the relevant page images further comprises generating the multi-modality index from input data by utilizing a vision language model.

12. The system of claim 10, wherein capturing the semantic and contextual relationship further comprises clustering multi-modality embeddings to identify representative states and reduce complexity of a state representation.

13. The system of claim 12, wherein converting the multi-modality content further comprises selecting an agent action using a Q-table based on the state representation for a reinforcement learning agent.

14. The system of claim 13, wherein converting the multi-modality content further comprises formatting the agent action into the instruction code along with the user query.

15. The system of claim 10, wherein converting the multi-modality content further comprises generating classification queries with an intent classifier by utilizing a context-classifying instruction code.

16. The system of claim 15, wherein converting the multi-modality content further comprises classifying the classification queries into an identified modality type by computing query text embeddings and comparing the embeddings of the classification queries with a content analyzer.

17. The system of claim 16, wherein converting the multi-modality content further comprises extracting content with the identified modality type from input data with the content analyzer to obtain extracted content.

18. The system of claim 10, wherein the corrective action further comprises controlling an autonomous vehicle with trajectories generated based on input videos processed by the DMMP system to avoid potential collisions.

19. A non-transitory computer program product comprising a computer-readable storage medium including a program code, wherein the program code when executed on a computer causes the computer to perform operations including:
extracting relevant page images from a multi-modality index with a dynamic multi-modality processing (DMMP) system;
capturing semantic and contextual relationship between a user query and multi-modality content of the relevant page images;
converting the multi-modality content of the relevant page images to an instruction code based on the semantic and contextual relationship captured with a context learning module of the DMMP system; and
correcting an issue identified by the DMMP system based on the instruction code that includes the user query by generating a corrective action with the DMMP system by utilizing the instruction code.

20. The non-transitory computer program product of claim 19, wherein the corrective action further comprises controlling an autonomous vehicle with trajectories generated based on input videos processed by the DMMP system to avoid potential collisions.
